(19) United States
(12) Patent Application Publication
(10) Pub. No.: US 2023/0049361 A1
(43) Pub. Date: Feb. 16, 2023

(54) TACTICAL RESPIRATOR MASK

(71) Applicant: O2 INDUSTRIES INC., Kitchener (CA)

(72) Inventors: Richard Devin SZASZ, Kitchener (CA); Norrie Tienlor SHENG, Waterloo (CA); Peter Lionel WHITBY, Kitchener (CA); Matthew Gerald HEXEMER, Minesing (CA); Victor BOGATCH, Scarborough (CA); Kevin Martin ARMOUR, Toronto (CA)

(21) Appl. No.: 17/794,125

(22) PCT Filed: Jan. 18, 2021
(86) PCT No.: PCT/CA2021/050045

§ 371 Date: Jul. 20, 2022

Related U.S. Application Data
(60) Provisional application No. 62/963,375, filed on Jan. 20, 2020.

(51) Int. Cl. A62B 18/02; A62B 18/08; A41D 13/11; A62B 23/02

(52) U.S. Cl. CPC A62B 18/025; A62B 18/08; A41D 13/1138; A62B 23/025

(57) ABSTRACT

A respirator mask, having a face cup shaped to cover a nose and a mouth of a user, the face cup having a face seal for providing an airtight flexible seal around the nose and mouth of the user, the face cup having at least one respiration port therethrough; a filter for filtering particulate elements from air, the filter received in an inhalation passage formed through the face cup by the at least one respiration port to filter air passing through the inhalation passage; and an accessory housing secured to the face cup to hold a mask accessory, the accessory housing being shaped to receive at least one accessory therein.

### TECHNICAL FIELD

The disclosure relates to respirator masks, and in particular to respirator masks adapted for use by military and law enforcement personnel.

### BACKGROUND

Respiratory masks are used in a wide variety of applications to protect a respiratory system from particles suspended in the air or from unpleasant or noxious gases. Such masks include filter masks which are commonly worn by persons who are in polluted environments in an effort to protect themselves from inhaling airborne contaminants. Filter masks typically have a fibrous or sorbent filter that is capable of removing particulate and/or gaseous contaminants from the air.

An example of a filter mask is disclosed in Patent Application Publication WO 2018/045456 filed by the present Applicant. The filter mask includes a face seal for providing an airtight flexible seal around the nose and mouth of a user, a support sealably attached to the face seal, wherein the support has an open area that allows for passage of incoming air and outlet valves for expelling exhaled air, a front shell for removably attaching to the support, wherein the front shell has inlet holes for allowing the incoming air to pass through the open area of the support, and a filter for filtering particulate elements from air. The filter is configured to be housed between the front shell and the support. The face seal provides a direct connection between the filter and the user.

Some users of respirator masks may need to use a respirator mask while also using an accessory such as a microphone. For example, law enforcement and military personnel may need to use a microphone while using a respirator mask to protect themselves from hazards such as airborne drugs at a crime scene or airborne lead released by firing a bullet. In some cases, a microphone may be clipped to a mask or held adjacent a mask by a boom arm or other support. In some cases, an opening may be cut into the mask and the microphone may be placed inside the opening or passed through the opening and placed inside the mask.

However, cutting an opening in the mask to position the microphone may compromise the filter functionality of the mask, or interfere with a user's face or mouth. Also, microphones held by boom arms or clipped to a respirator mask may result in a muffled sound due to material between the user's mouth and the microphone. Such solutions may also interfere with the movement of a respirator mask user and/or the functionality of the respirator mask.

There is accordingly a need for an improved respirator mask.

### SUMMARY

According to a first aspect, there is provided a respirator mask, comprising a face cup shaped to cover a nose and a mouth of a user, the face cup having a face seal for providing an airtight flexible seal around the nose and mouth of the user, the face cup having at least one respiration port therethrough; a filter for filtering particulate elements from air, the filter received in an inhalation passage formed through the face cup by the at least one respiration port to filter air passing through the inhalation passage; and an accessory housing secured to the face cup to hold a mask accessory, the accessory housing being shaped to receive at least one accessory therein.

In some embodiments, the accessory housing is a hollow tubular housing.

The accessory housing may have at least one first open end for receiving at least a first accessory and at least one second open end opposite the at least one first open end for receiving at least a second accessory.

The accessory housing may be a hollow cylindrical tubular housing.

The respirator mask may comprise an accessory carrier configured to carry at least one accessory, the accessory carrier being shaped to be received within the accessory housing.

The accessory housing may be in fluid communication with an interior of the face cup.

The mask accessory may be a microphone having a microphone body, the accessory housing shaped to house the microphone body.

The mask accessory may be an external hose connector for connecting to an external hose, the external hose connector having a valve in a connector valve body to close the at least one open end when the external hose is disconnected, the accessory housing shaped to house the connector valve body.

The mask accessory may be at least one of a fluid valve and an essential oil diffuser.

The at least one respiration port may be an inhalation port and an exhalation port, and an inhalation passage is formed through the inhalation port, the face cup forming a filter carrier frame in the inhalation passage to receive a filter cartridge in the inhalation passage.

According to a second aspect, there is provided a respirator mask, comprising a face cup to cover a nose and a mouth of a user and having a face seal for providing an airtight flexible seal around the nose and mouth of the user, the face cup having at least one respiration port therethrough and an inhalation passage formed through the face cup by the at least one respiration port, the face cup having a carrier frame in the inhalation passage to receive the filter cartridge in the inhalation passage to filter fluid passing through the inhalation passage; and a filter cover, the filter cover removably secured to the face cup to overlay a filter cartridge received in the carrier frame, the carrier frame and the filter cover forming a cartridge housing to enclose the filter cartridge to protect the filter cartridge from an ambient environment.

In some embodiments, the filter cartridge is a pleated filter cartridge having an open inlet face.

The filter cartridge may have an open outlet face.

The respirator mask may have a rigger to provide at least two strap connection points projected from the sides of the cartridge housing to facilitate connection of a strap to the respirator mask.

According to a third aspect, there is provided a respirator mask, comprising a face cup to cover a nose and a mouth of a user, the face cup having at least one respiration port therethrough and having a face seal for providing an airtight flexible seal around the nose and mouth of the user, the face seal providing a smooth inner surface of the face cup to facilitate cleaning of the face cup, and an exoskeleton frame secured to an outside surface of the face seal to support the face seal from an exterior of the face seal; and a filter for filtering particulate elements from air, the filter received in an inhalation passage formed through the face cup by the at least one respiration port to filter air passing through the inhalation passage.

In some embodiments, the filter is a replaceable filter cartridge removably secured to the respirator mask.

The exoskeleton frame may include a lattice frame having a plurality of support bars to support the face seal.

### BRIEF DESCRIPTION OF THE DRAWINGS

The drawings included herewith are for illustrating various examples of systems, methods, and apparatus of the present specification. In the drawings:

FIG. 1 is a top port perspective view of a respirator mask in accordance with an embodiment, with a strap attached;

FIG. 2 is bottom, front, starboard perspective view of the respirator mask of FIG. 1;

FIG. 3 is an exploded bottom, front, starboard perspective view of the respirator mask of FIG. 1;

FIG. 4 is a top, front, port perspective view of the respirator mask of FIG. 1;

FIG. 5 is an exploded top, front, port perspective view of the respirator mask of FIG. 1;

FIG. 6 is a bottom plan view of the respirator mask of FIG. 1;

FIG. 7 is a bottom exploded plan view of the respirator mask of FIG. 1;

FIG. 8 is a port exploded elevation view of the respirator mask of FIG. 1;

FIG. 9 is a rear elevation view of the respirator mask of FIG. 1;

FIG. 10 is a front elevation view of the respirator mask of FIG. 1;

FIG. 11 is a cross sectional view of the respirator mask of FIG. 1, taken along line 11-11 of FIG, 10;

FIG. 12 is a bottom, rear perspective view of a lattice of he respirator mask of FIG. 1:

FIG. 13 is a bottom, front perspective view of he lattice of the respirator mask of FIG. 1;

FIG. 14 is a bottom, front perspective view of a seal of the respirator mask of FIG. 1;

FIG. 15 is a top, rear perspective view of the seal of the respirator mask of FIG. 1;

FIG. 16 is a top, front perspective view of a rigger body of the respirator mask of FIG. 1;

FIG. 17 is a bottom, rear perspective view of the rigger body of the respirator mask of FIG. 1;

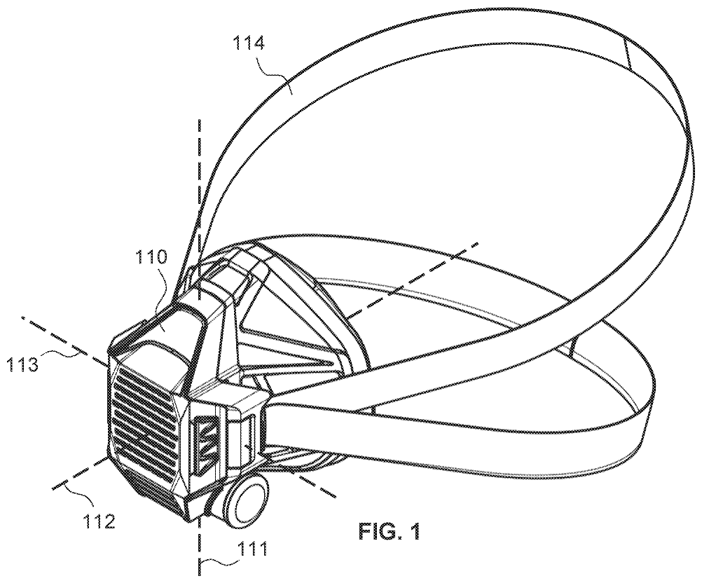

FIG. 13 is a perspective view of a sealing gasket of the respirator mask of FIG. 1;

FIG. 19 is a rear perspective view of a filter cover of the respirator mask of FIG. 1;

FIG. 20 is a front perspective view of a filter cartridge;

FIG. 21 is a rear, top perspective view of the filter cartridge of FIG. 20 received in the filter cover of FIG. 19;

FIG. 22 is a perspective exploded view of an accessory carrier of the respirator mask of FIG. 1;

FIG. 23 is a perspective exploded view of an accessory carrier in accordance with an embodiment;

FIG. 24 is a perspective view of the accessory carrier of FIG. 23;

FIG. 25 is a side elevation view of the accessory carrier of FIG. 23;

FIG. 26 is a perspective exploded view of an accessory carrier in accordance with an embodiment; and

FIG. 27 is an end elevation view of the accessory carrier of FIG. 26.

### DETAILED DESCRIPTION

Various apparatus or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

Referring now to FIG. 1, depicted is a tactical respirator mask 110. Respirator mask 110 has a vertical axis 111, a longitudinal axis 112, and a transverse axis 113. Respirator mask 110 may be used with a strap for holding the respirator mask 110 to a user's head. In the illustrated example, respirator mask 110 is used with a head strap 114, however in other embodiments other straps may be used. For example, a strap may terminate in a clip to be secured to a buckle on a helmet or other external structure. In some embodiments, the strap can be releasably secured to a buckle on a hook-and-loop pad so that the hook-and-loop pad may be secured to, for example, a hook-and-loop surface of a helmet.

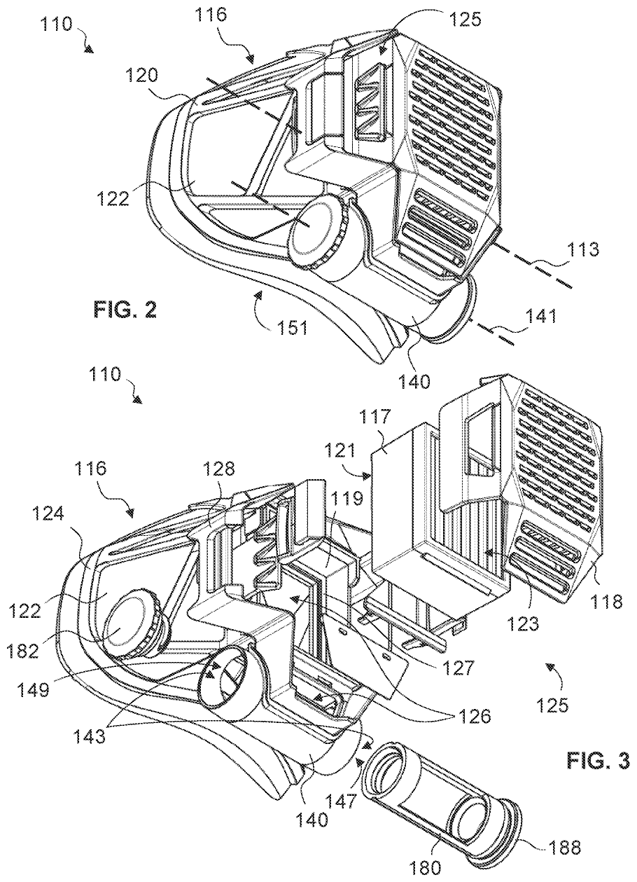

Referring now to FIGS. 2 and 3, respirator mask 110 includes a face cup 116 to cover the nose and the mouth of a user. Respirator mask 110 also includes a filter cover 118. Face cup 116 has a face seal 122 for providing an airtight flexible seal around the nose and mouth of the user. Face seal 122 may be formed of, for example, a soft silicone and/or a harder coating over a soft base such as a hard nylon over a silicon base.

Face cup 116 also includes a supporting frame 120. Illustrated frame 120 includes a lattice 124 and a rigger 128 (FIG. 3). Lattice 124 is secured to seal 122, such as by being glued or welded or held by fasteners, and forms an exoskeleton lattice frame to support seal 122. Rigger 128 is secured to lattice 124, such as by being glued or welded or held by fasteners, to provide mounting points for straps. The face cup 116 has two respiration ports 126 therethrough, although in other embodiments a respirator mask 110 may have only one respiration port or more than two.

In the illustrated example, an accessory housing 140 is part of a lower end of frame 110 and is formed by lattice 124. The accessory housing 140 has open ends 143, each of which is shaped to receive a mask accessory therein. However, in other embodiments an accessory housing may have a single opening shaped to receive a mask accessory or more than two openings, and in some embodiments a respirator mask may include more than one accessory housing.

In the illustrated example, the accessory housing 140 is a single hollow, cylindrical tube and the two open ends 143 are a port open end 147 of the hollow tubular housing 140 and a starboard open end 149 of the hollow tubular housing 140 opposite the port open end 147. Illustrated accessory housing 140 has an axis 141 parallel to the transverse axis 113 of the mask 110.

A hollow tubular accessory housing may allow the accessory housing to be secured to a face cup of a mask without projecting substantially from the mask or extending into an interior of the face cup. A hollow tubular member may be able to receive more than one accessory, and may allow all accessories received to be in communication with an interior of the face cup through a single respiration port. However, in other embodiments other accessory housings may be used. For example, a tubular housing may be square in cross section rather than circular and/or may have only a single open end. In some embodiments, a tube may have more than one opening at an end and/or openings other than at an end.

In the illustrated example, open ends 143 are in fluid communication with interior 151 of face cup 116 to allow for fluid transfer therebetween and to reduce sound distortion. This may facilitate use of open ends with an oxygen connector joining the mask 110 to an oxygen line from an oxygen supply, or may facilitate use with a microphone. However, in some embodiments an open end may not be in fluid communication with an interior of a face cup of a respirator mask.

Fluid communication may permit the movement of gas such as oxygen gas, but also may allow for the movement of liquids such as sweat and saliva. While an accessory housing may be otherwise arranged, in the illustrated embodiment the accessory housing 140 extends below the seal 122, and liquid may accordingly pool in the accessory housing 140 rather than next to the face of a user. The bottom of the inside of seal 122 is also sloped to direct liquid into the accessory housing 140. In some embodiments, a mask may also include a spit valve or other release valve to allow a user to release accumulated liquid by opening a valve rather than lifting the mask. In some embodiments, a spit valve is an accessory removably housed in the accessory housing, while in some embodiments a spit valve is formed in a wall of the accessory housing or another wall of a respirator mask. A spit valve may also be used to release other fluids such as sweat or blood.

In another example, an accessory may be an essential oil diffuser or a connection to an essential oil diffuser or other scent accessory.

To prevent unwanted fluid from passing in through the open ends 143, they may be fluidly closed from an ambient environment. Open ends 143 may be closed by accessories received therein. However, in the illustrated example they are closed by a removable accessory carrier 180 and blank cap 182. Blank cap 182 is fluidly impermeable and may be threaded onto accessory carrier 180 to hold accessory carrier 180 and blank cap 182 in accessory housing 140. Accessory carrier 180 includes an end cap 188. End cap 188 is also fluidly impermeable and cooperates with blank cap 182 to close open ends 143. Accessory carrier 180 may be reversible so that if one of blank cap 182 and end cap 188 is replaced with an accessory the user may choose which side of the mask the accessory comes out on. For example, if the accessory is a microphone it may need to be joined by a wire to a radio and a right-handed user of a firearm may prefer that the wire come out on a left side of their head, while a left-handed user may prefer that the wire come out on a right side of their head.

Respirator mask 110 may receive at least one filter aligned with at least one respiration port to filter air passing through the aligned respiration port. Respirator mask 110 is a filter cartridge mask and may include a cartridge housing in which to receive a filter cartridge. However, in other examples the respirator mask may use a flat filter or may be a filter cartridge mask that does not include a cartridge housing.

Continuing to refer to FIGS. 2 and 3, in the illustrated example, a filter cartridge 117 is received between the face cup 116 and the filter cover 118. Face cup 116 forms a filter carrier frame 119 to receive filter cartridge 117 and support an outlet face 121 of the filter cartridge. The filter cover 118 is removably secured to the face cup 116 to overlay the inlet face 123 of the filter cartridge 117. Together, the carrier frame 119 and the filter cover 118 form a cartridge housing 125 to enclose the filter cartridge 117 and hold the filter cartridge 117 therein.

A filter cartridge mask may allow a user to achieve a cheek weld when also firing a firearm. The filter cartridge may be moved to the center of the mask to reduce the size of the sides of the mask so that the mask does not interfere with the use of the firearm.

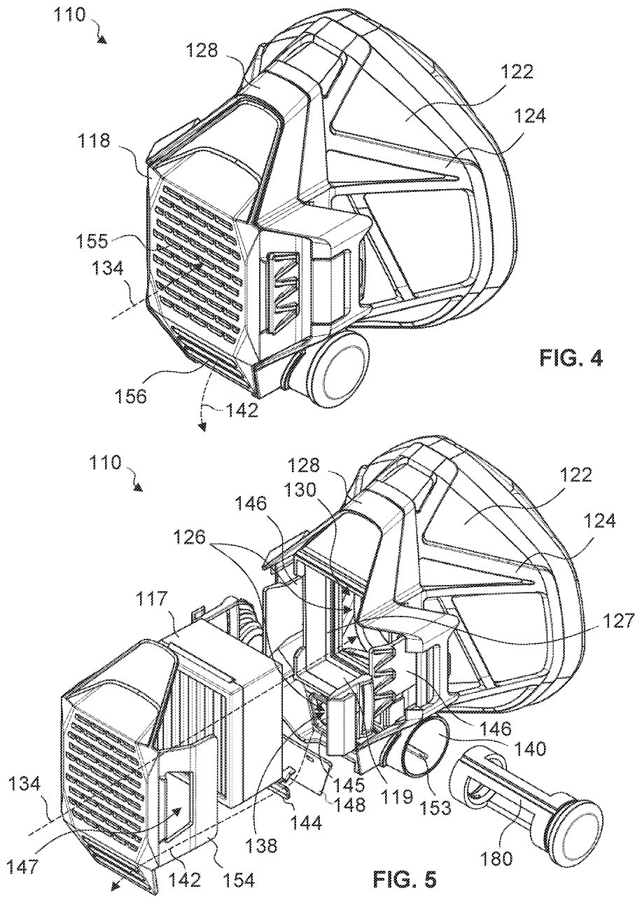

Referring now to FIGS. 4 and 5, the respiration ports 126 in the illustrated example are an inhalation port 130 through which an inhalation passage 134 may pass through the face cup 116 and an exhalation port 138 through which an exhalation passage 142 may pass through the face cup 116.

In the illustrated example, filter cartridge 117 is received in the inhalation passage 134 of respirator mask 110 to filter air passing therethrough. In the illustrated example, a sealing gasket 127 is received in carrier frame 119 on a rear seat of carrier frame 119 to seal an interface between filter cartridge 117 and a rim of inhalation port 130.

Exhalation passage 142 is closed by a one-way valve allowing fluid flow outward while impeding inward fluid flow. In the illustrated example, the exhalation passage 142 is closed by a valve flap 148 held in position by a valve clip 144. The valve clip 144 is snap-fitted to the face cup 116. The valve flap 148 may be made of silicone and may be sufficiently flexible to allow a force of an exhalation to displace the lower end an open the exhalation passage 142. Valve flap 148 seats against seat 145 of face cup 116 to prevent the valve flap 148 from being displaced by a force of an inhalation. Flap 143 is also removable and replaceable. An exhalation valve that is fixed at the top and flapped at the bottom may provide a simple and effective exhalation valve in some embodiments.

Illustrated filter cover 118 includes a grill 155 through which inhalation passage 134 may pass, corresponding to inhalation port 130 through face cup 116. Filter cover 154 also extends down to overlay exhalation port 138 and includes a grill 156 through which exhalation passage 142 may pass, corresponding to exhalation port 138 through face cup 116.

Illustrated filter cover 118 is removably securable to face cup 116 by way of snap fit projections 146 of face cup 116 corresponding to openings 147 of filter cover 118. Illustrated snap fit projections 146 have large depressible ends 139 (FIG. 13) to be depressed to release filter cover 118. The depressible ends of the projections 146 are large to facility replacement of the filter cartridge by gloved fingers.

Also depicted is a projection 153 in accessory housing 140. Projection 153 may cooperate with a groove on accessory carrier 180 to prevent axial rotation of accessory carrier 180 within accessory housing 140. The prevention of axial rotation of accessory carrier 180 may also allow a cap or threaded accessory to be screwed in without requiring the other end to be stabilized by hand, which may allow for one-handed attachment of an accessory.

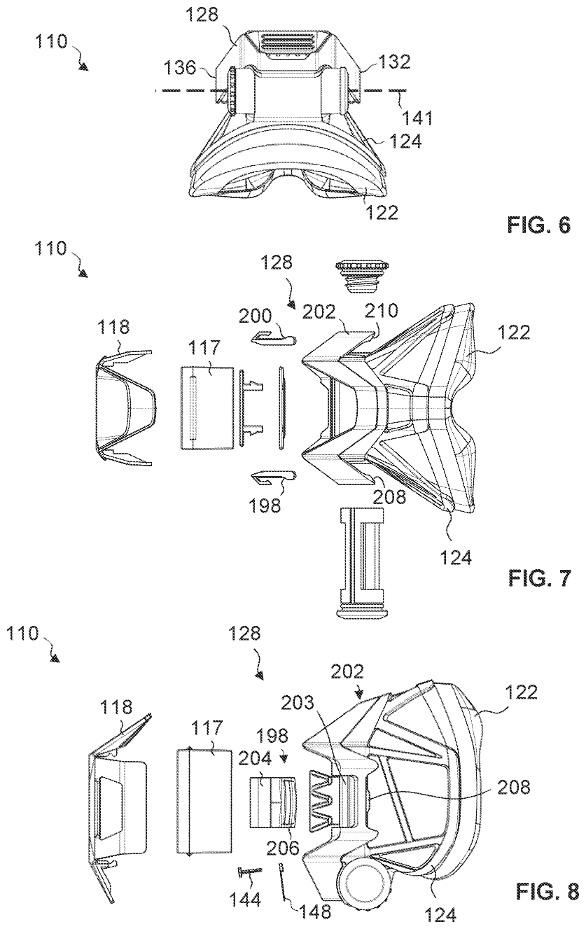

Referring now to FIGS. 6 to 8, rigger 128 provides a port strap mounting point 132 and a starboard strap mounting point 136 projected out from the sides of cartridge housing 125 so that a strap may more easily be secured without disturbing the seal 122. In the illustrated example, rigger 128 is glued to lattice 124 of the frame 120 of face cup 116. Rigger 128 is provided for use with a port d-ring 198 and a starboard d-ring 200. A rigger body 202 of rigger 128 forms a platform to which the port and starboard d-rings 198, 200 may be removably snap-fitted. Each of the port and starboard d-rings 198, 200 includes a strap buckle or other strap attachment.

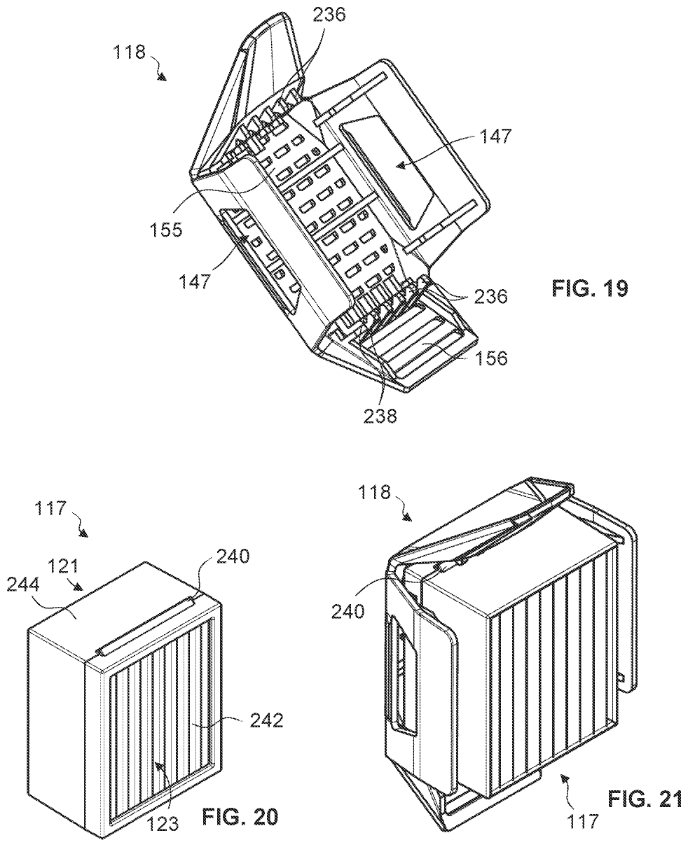

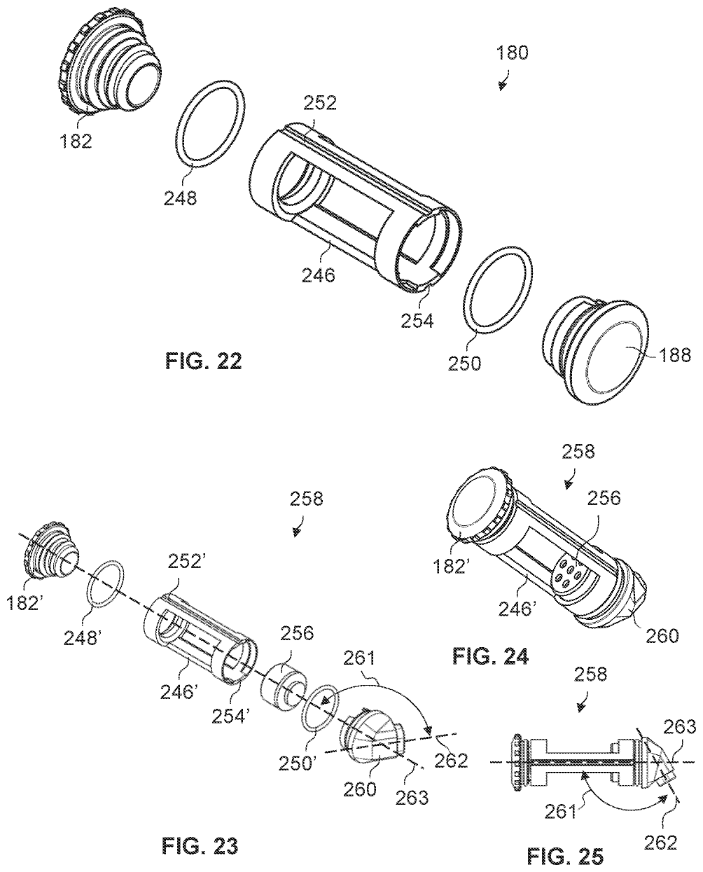

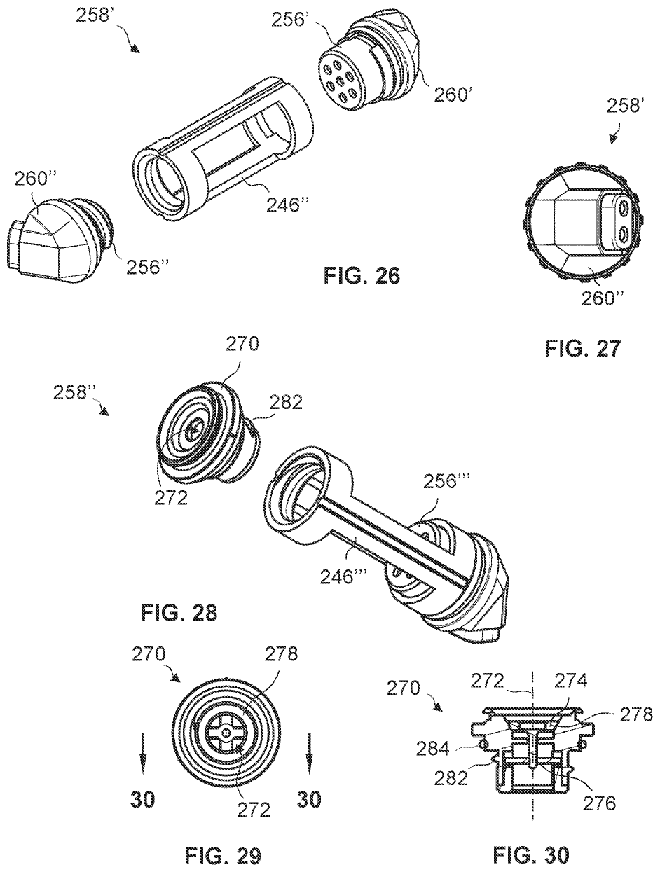

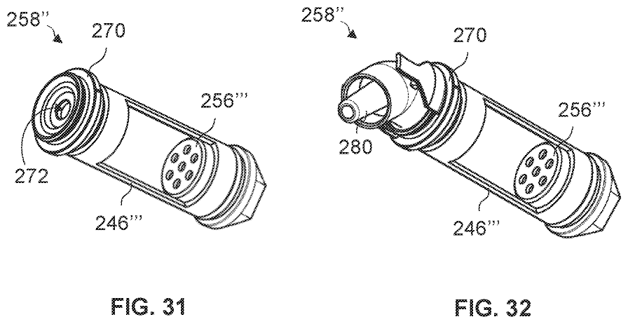

Each of port and starboard sides of rigger body 202 also includes a tooth 208, 210 (see also FIG. 17), extending transversely inwards and aligned with the corresponding strap buckle when d-rings 198, 200 are snapped to rigger body 202. The tooth 208, 210 may cooperate in gripping a strap threaded through the buckle of the d-ring 198, 200 and inhibit loosening of the strap. Referring specifically to FIG. 8, port d-ring 198 is shown, having a snap-fit clip 204 to snap onto port snap formation 203 of rigger body 202 and a buckle 206 corresponding to port tooth 208.

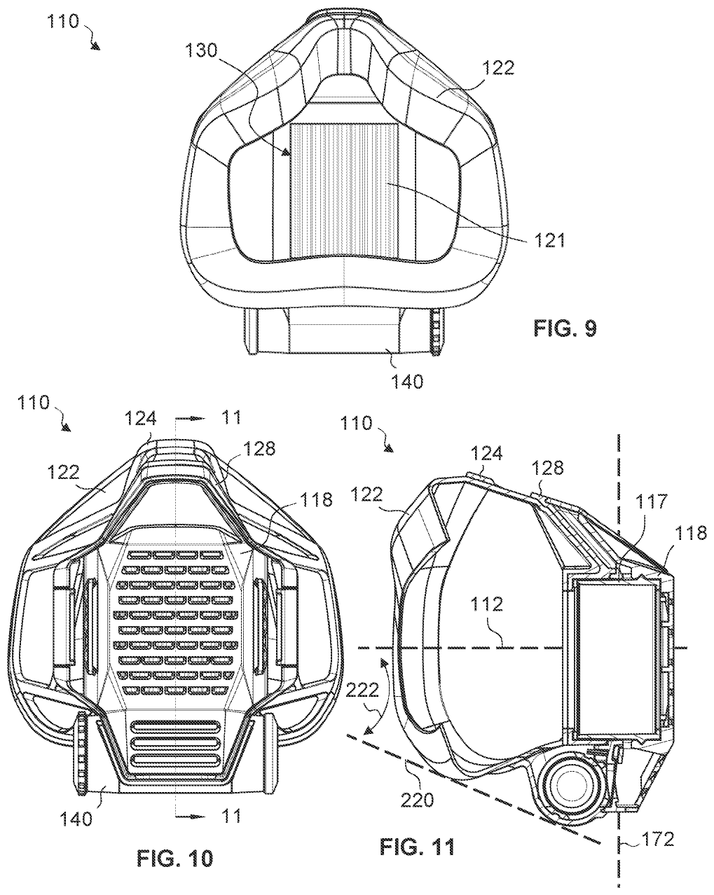

Referring to FIGS. 9 to 11 inhalation port 130 of illustrated respirator mask 110 is open, leaving outlet face 121 of filter cartridge 117 visible. Accessory housing 140 is a lower part of the mask 110 and extends below seal 122. Accordingly, a resting plane 220 of mask 110 when placed on a flat surface is at an angle 222 to the longitudinal axis 112 of the mask 110. Illustrated resting plane 220 is a plane spanning three locally lowest points of mask 110. In the illustrated example, resting plane 220 is a plane spanning the lowest port-side point of seal 122, the lowest starboard-side point of seal 122, and the lowest point of accessory housing 140.

Angle 222 is greater than 0° so that when mask 110 is not in use and placed on a flat surface, the face opening 224 of seal 122 is angled downward to reduce the amount of falling debris that can accumulate in seal 122. Angle 222 is also less than 90°, so that the portion of seal 122 that mates with the skin of a user's face is not in direct contact with the flat surface on which the mask 110 is placed. In the illustrated example, angle 122 is approximately 25°, although in other embodiments angle 122 may be between 10° and 80°.

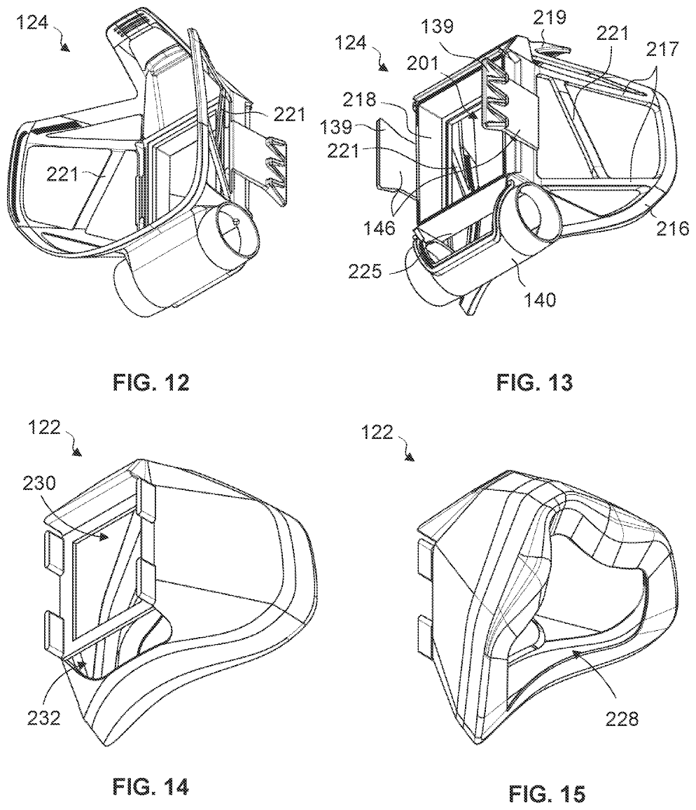

Referring now to FIGS. 12 and 13, lattice 124 of frame 120 is shown without the seal 122. Lattice 124 is provided to support seal 122 by providing a rigid or semi-rigid structural member to maintain the cup shape of face cup 116. For example, lattice 124 may be made of a firm plastic. Lattice 124 includes a perimeter bar 216 and reinforcing bars 217 provided to support a perimeter of seal 122. A nose member 219 is provided to support a nose bridge portion of seal 122. Lattice 124 forms a carrier frame portion 218 to frame an inhalation opening through seal 122 and to form a base of carrier frame 119. Lattice 124 includes an exhalation rim 225 to frame an exhalation opening in seal 122. Lattice 124 also includes accessory housing 140 and snap fit projections 146.

Lattice 124 is provided to support seal 122 and may be secured to seal 122 by way of, for example, plastic welding, adhesive, or one or more fasteners. In some embodiments an opening of seal 122 may be aligned with an opening through lattice 124, and the interface between the openings may be protected by one or more side bars of lattice 124. In the illustrated example, an inhalation opening of seal 122 may be bonded around a rim of the opening to carrier frame portion 218, and side bars 221 are provided adjacent the inhalation opening of seal 122 to prevent a user from placing pressure on seal 122 near the inhalation opening 201. A user gripping respirator mask 110 may palm the filter cover 118 and grasp the face cup 116 on each of port and starboard sides by applying pressure to side bars 221 rather than applying pressure directly to seal 122.

Frame 120, including lattice 124, is an exoskeleton frame, leaving an inside 151 of respirator mask 110 substantially smooth so as to minimize accumulation of debris inside respirator mask 110 and to facilitate the cleaning of respirator mask 110. A smooth interior may also assist in directing sound to a microphone accessory in some embodiments. An exoskeleton may also provide a firm surface on an exterior of the mask for contact with external objects, such as the stock of a firearm when a user of the mask firing the firearm. An exoskeleton may have a soft exterior surface for contact with external objects.

Referring now to FIGS. 14 and 15, seal 122 is shown in isolation. Seal 122 has a face opening 228 in a rear of the seal 122, and an inhalation opening 230 and an exhalation opening 232 in a front of the seal 122. Inhalation opening 230 forms a part of inhalation port 130 through face cup 116, through which an inhalation passage 134 may pass. Exhalation opening 232 forms a part of exhalation port 138 through face cup 116, through which an exhalation passage 142 may pass. A perimeter of face opening 228 is shaped to provide an airtight flexible seal around the nose and mouth of the user.

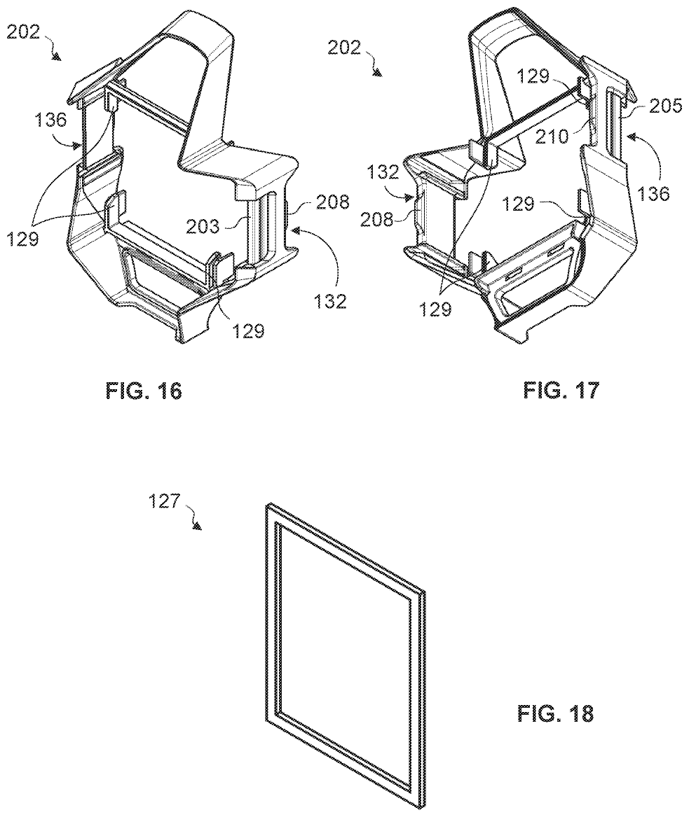

Referring now to FIGS. 16 and 17, rigger body 202 is shown in greater detail. Port strap mounting point 132 and a starboard strap mounting point 136 each include a snap formation 203, 205 and a tooth 208, 210. As mentioned above, rigger body 202 may be secured to lattice 124 by way of, for example, plastic welding, adhesive, or one or more fasteners. The port and starboard d-rings 198, 200 (FIG. 7) may be snap-fitted to rigger body 202 to provide buckles through which a strap or straps may be threaded. Rigger 128 may also form part of carrier frame 119, and illustrated rigger body 202 includes wall portions 129 which form parts of the walls of carrier frame 119.

Illustrated example teeth 208, 210 extend rearwardly along longitudinal axis 112 and outward along transverse axis 113. When a strap secured to d-rings that are snapped to rigging body 202 is drawn tight, such as pulled back around a head of the user, a portion of the strap adjacent the teeth 208, 210 will be generally parallel to the longitudinal axis and will not contact the teeth 208, 210. When a strap secured to d-rings that are snapped to rigging body 202 is loose, such as when the mask is removed from a head and set down, the teeth 208, 210 will inhibit loosening of the strap.

Referring now to FIG. 18, sealing gasket 127 is shown in isolation. Sealing gasket 127 is rectangular in shape to frame a rectangular inhalation port 130 and prevent fluid from entering inhalation port 130 without passing through filter cartridge 117. However in other embodiments, sealing gasket 127 may take on other shapes corresponding to the shape of an inhalation port or may be built into a face cup such as face cup 116. For example, carrier frame portion 218 of lattice 124 may include an outer layer of soft plastic to act as a sealing gasket. Sealing gasket 127 may be glued or otherwise secured in place within carrier frame 119.

In some embodiments, a sealing gasket or other sealing mechanism may be applied at an alternate location. For example, a sealing gasket may be applied near the top of the carrier frame by introducing a lip on the filter cartridge body. In some embodiments, the soft sealing material could also be part of the cartridge instead of the lattice.

Referring now to FIGS. 19 to 21, filter cover 118 includes inhalation grill 155 and exhalation grill 156, and is removably securable to face cup 116 by way of snap fit projections 146 of face cup 116 (FIG. 5) corresponding to openings 147 of filter cover 118. Filter cover 118 also includes supports 236 having notches 238 to hold projection 240 of filter cartridge 117.

Filter cartridge 117 includes a pleated filter membrane 242 held in a membrane mount 244. In the illustrated embodiment, membrane mount 244 surrounds the membrane 242 but leaves both the inlet face 123 and the outlet face 121 open. Because respirator mask 110 forms a cartridge housing 125, the inlet face 123 of the filter cartridge 117 may be open rather than covered. This allows for a simpler cartridge construction, reduced material use with less bulk and less waste, and also allows the user to visually inspect the filter cartridge 117 to determine whether the cartridge 117 is fit for continued use. The cartridge housing 125 may also keep the filter cartridge from projecting substantially from the mask and interfering with the activities of the user.

A variety of filter membranes may be used, such as membranes to remove asbestos or mold. However, in some embodiments membrane 242 may be a lead-removal membrane to remove lead from an airstream, such as lead generated during firing of a weapon adjacent the mask 110. Membrane 242 and/or mount 244 may be biodegradable, such as so that it will degrade if discarded by a user such as a soldier in the field.

Referring now to FIG. 22, illustrated removable accessory carrier 180 includes a carrier body 246. End cap 188 is rigidly secured to carrier body 246, while blank cap 182 may be threaded on and off of carrier body 246 to allow the accessory carrier 180 to be removably secured in accessory housing 140. Accessory carrier 180 also includes accessory sealing gaskets 248 and 250 to inhibit fluid flow past accessory carrier 180 through accessory housing 140. Grooves 252 and 254 are provided to cooperate with projections 153 (FIG. 5) of accessory housing 140 to prevent axial rotation of the accessory carrier 180 within the accessory housing 140.

In some embodiments, a cap or accessory may be secured directly to the accessory housing 140 to simplify construction and allow for use without accessory carrier 180. For example, an accessory or cap may be threaded onto threads molded into a wall of the accessory housing 140 in some embodiments. However, an accessory carrier and substantially smooth inner surface of accessory housing 140 may allow for more variation in accessory use, such as interchangeability or a redesign of an accessory system without redesigning the accessory housing. It may also allow for the use of a smaller accessory housing 140 with a fixed-size accessory, since the accessory can be rigidly secured to one end of the accessory carrier 180 and the opposite end of the accessory carrier 180 may be threaded to receive a threaded cap or other releasable fastening apparatus, rather than expanding the size of the accessory by forming threads around the fixed-size accessory.

Referring now to FIGS. 23 to 25, an accessory carrier 258 is similar in many respects to accessory carrier 180 but with a microphone accessory 256 taking the place of end cap 188. Similar to accessory carrier 180, accessory carrier 258 includes a thread-able blank cap 182′, sealing gaskets 248′, 250′, and grooves 252′, 254′ in body 246′. However microphone 256 is secured to accessory carrier 258 opposite blank cap 182′ to be housed in accessory housing 140. Microphone 256 is communicatively coupled to a connector cap 260 via electrical wires. Illustrated connector cap 260 includes a two-prong female connection. Connector cap 260 may be coupled to an exterior communications and/or power line. Connector cap 260 may also act as a cap to cooperate with blank cap 182′ in holding accessory carrier 258 within accessory housing 140. As illustrated, connector cap 260 may define a connector angle 261 between a connector axis 262 and a carrier axis 263. The connector angle 261 may be less than 180° to keep a connection wire or other line tighter against the face of a user and more than 10° to keep the connection wire or other line from driving into the face of user. For example, a connector angle 261 may be angled to direct a wire towards a head strap so the wire can be clipped to the head strap, such as to run up to a helmet or headset, In some embodiments angle 261 may be adjustable. For example, connector cap 260 may include an adjustable joint.

Referring now to FIGS. 26 and 27, an accessory carrier 258′ is similar in many respects to accessory carrier 258, but with a microphone accessory 256″ taking the place of blank cap 182. A second microphone may allow a first microphone to connect to a first radio system while a second microphone connects to a second radio system. For example, many military personal use a first radio system for communications with a base and a second, separate radio system for communications with a local group, and may need to hook the radio systems each to its own dedicated microphone. In another example, a first radio system may be a close range communications system for a local group while the second radio system is a long range communications system for a remote group.

In some embodiments, other accessories may be used. For example, an oxygen line connector may be used in place of one or both of end cap 188 and blank cap 182. An oxygen line connector may be, for example, a valve apparatus biased in a closed arrangement and provided as a standby connection for an oxygen line so that a user may connect an oxygen line when needed, the valve apparatus being opened by the connection of a corresponding apparatus which may be secured to the end of an oxygen line. In some embodiments, a user may use one accessory in one open end and a different accessory in another open end, such as a microphone in one open end and an oxygen line connector in another open end.

Referring now to FIGS. 28 to 32, an accessory carrier 258″ is similar in many respects to accessory carrier 258′, with an oxygen connector 270 taking the place of microphone accessory 256″. Body 246′″ supports a microphone accessory 256′″ rigidly secured to one end and an oxygen connector 270 threadably secured to the opposite end. Oxygen connector 270 has a fluid passage 272 therethrough, blocked by a movable valve 274. Valve 274 is biased by resilient system 276, such as a spring system, in a withdrawn position in which it is seated against seat 278.

Valve 274 may then be opened when an oxygen line is available. For example, when hose connector 280 is brought adjacent oxygen connector 270 a magnet in hose connector 280 may draw valve 274 into an open position by attracting a magnet secured to valve 274. In another example, a mechanical coupling element may push the valve 274 open.

Oxygen connector 270 may bear threading 282 to be threaded onto body 246″ of accessory carrier 258″. An o-ring 284 similar to sealing gasket 248 may be used to seal a perimeter of oxygen connector 270 to prevent a by-pass flow of fluid.

In some embodiments, a connector such as connector 270 may be used to connect to an exterior hose or line carrying any fluid. The fluid may be oxygen, water, scented air, etc.

A mask incorporating an accessory housing, a filter cartridge housing, and/or another aspect of the present disclosure may be used in a variety of circumstances. While mask 110 is described for use by military or police personnel, in some embodiments a mask incorporating one or more aspects of the present disclosure may be used for oil & gas industry applications, construction industry applications, manufacturing applications, racing applications, etc.

The present invention has been described here by way of example only. Various modification and variations may be made to these exemplary embodiments without departing from the scope of the invention, which is limited only by the appended claims.

1. A respirator mask, comprising:
a face cup shaped to cover a nose and a mouth of a user, the face cup having a face seal for providing an airtight flexible seal around the nose and mouth of the user, the face cup having at least one respiration port therethrough;
a filter for filtering particulate elements from air, the filter received in an inhalation passage formed through the face cup by the at least one respiration port to filter air passing through the inhalation passage; and
an accessory housing secured to the face cup to hold a mask accessory, the accessory housing being shaped to receive at least one accessory therein.

2. The respirator mask of claim 1, wherein the accessory housing is a hollow tubular housing.

3. The respirator mask of claim 2, wherein the accessory housing has at least one first open end for receiving at least a first accessory and at least one second open end opposite the at least one first open end for receiving at least a second accessory.

4. The respirator mask of claim 2, wherein the accessory housing is a hollow cylindrical tubular housing.

5. The respirator mask of claim 4, further comprising an accessory carrier configured to carry at least one accessory, the accessory carrier being shaped to be received within the accessory housing.

6. The respirator mask of claim 1, wherein the accessory housing is in fluid communication with an interior of the face cup.

7. The respirator mask of claim 1, wherein the mask accessory is a microphone having a microphone body, the accessory housing shaped to house the microphone body.

8. The respirator mask of claim 1, wherein the mask accessory is an external hose connector for connecting to an external hose, the external hose connector having a valve in a connector valve body to close the at least one open end when the external hose is disconnected, the accessory housing shaped to house the connector valve body.

9. The respirator mask of claim 1, wherein the mask accessory is at least one of a fluid valve and an essential oil diffuser.

10. The respirator mask of claim 1, wherein the at least one respiration port is an inhalation port and an exhalation port, and an inhalation passage is formed through the inhalation port, the face cup forming a filter carrier frame in the inhalation passage to receive a filter cartridge in the inhalation passage.

11. A respirator mask, comprising:
a face cup to cover a nose and a mouth of a user and having a face seal for providing an airtight flexible seal around the nose and mouth of the user, the face cup having at least one respiration port therethrough and an inhalation passage formed through the face cup by the at least one respiration port, the face cup having a carrier frame in the inhalation passage to receive the filter cartridge in the inhalation passage to filter fluid passing through the inhalation passage; and
a filter cover, the filter cover removably secured to the face cup to overlay a filter cartridge received in the carrier frame, the carrier frame and the filter cover forming a cartridge housing to enclose the filter cartridge to protect the filter cartridge from an ambient environment.

12. The respirator mask of claim 10, wherein the filter cartridge is a pleated filter cartridge having an open inlet face.

13. The respirator mask of claim 10, wherein the filter cartridge has an open outlet face.

14. The respirator mask of claim 10, having a rigger to provide at least two strap connection points projected from the sides of the cartridge housing to facilitate connection of a strap to the respirator mask.

15. A respirator mask, comprising:
a face cup to cover a nose and a mouth of a user, the face cup having at least one respiration port therethrough and having:
a face seal for providing an airtight flexible seal around the nose and mouth of the user, the face seal providing a smooth inner surface of the face cup to facilitate cleaning of the face cup, and
an exoskeleton frame secured to an outside surface of the face seal to support the face seal from an exterior of the face seal; and
a filter for filtering particulate elements from air, the filter received in an inhalation passage formed through the face cup by the at least one respiration port to filter air passing through the inhalation passage.

16. The respirator mask of claim 14, wherein the filter is a replaceable filter cartridge removably secured to the respirator mask.

17. The respirator mask of claim 14, wherein the exoskeleton frame includes a lattice frame having a plurality of support bars to support the face seal.
